(19) United States
(12) Patent Application Publication
(10) Pub. No.: US 2019/0240706 A1
(43) Pub. Date: Aug. 8, 2019

(54) LOOFAH HOLDER

(71) Applicant: Michael Zahabian, Paramus, NJ (US)

(72) Inventor: Michael Zahabian, Paramus, NJ (US)

(21) Appl. No.: 15/888,383

(22) Filed: Feb. 5, 2018

(51) Int. Cl. B08B 3/04; A47K 7/02; B08B 1/00; B08B 1/02

(52) U.S. Cl. CPC B08B 3/041; A47K 7/024; Y10T 428/24017; B08B 1/02; B08B 1/002

(57) ABSTRACT

Disclosed embodiments provide systems and methods for self-cleaning of a user's back. In embodiments, a back panel is affixed to a shower wall via one or more suction cups. The back panel includes a fastening mechanism that allows fastening of a loofah sheet to the back panel. The back panel is in a form with a concavity that contours to a human back. Water and/or liquid soap may be applied to the loofah sheet. The user can then walk backwards in the shower as to contact his/her back to the loofah sheet that is affixed to the back panel, and move his/her back relative to the back panel, thereby washing the back of the user.

### FIELD OF THE EMBODIMENTS

The disclosed embodiments relate generally to bath products, and more particularly, to a loofah holder.

### BACKGROUND

Skin health is important for appearance, and furthermore, skin performs many essential tasks for the human body. Skin protects the body from viruses and bacteria that people are constantly exposed to. Having healthy skin also helps the body keep its temperature at a constant level. Thus, healthy skin is an important component of overall well-being.

The outermost skin layer, referred to as the epidermis, is a first line of defense against intruders, such as germs, and the elements. The epidermis protects the second layer of skin, the dermis, which contains important structures like sweat glands and hair follicles. An important component of skin health is proper cleaning of the skin. Skin conditions such as acne can be caused by a variety of factors, including oily pores. Proper cleaning of skin can mitigate the acne caused by oily pores. It is therefore desirable to have improvements in bath products that facilitate skin care.

### SUMMARY OF THE EMBODIMENTS

In one embodiment, there is provided, a loofah holder comprising: a back panel; a plurality of legs extending from the back panel; and a suction cup disposed on each leg of the plurality of legs.

In another embodiment, the back panel comprises a concave cross section.

In another embodiment, the back panel comprises a maximum concavity ranging from 12 centimeters to 22 centimeters.

Another embodiment further comprises a fastener disposed on a top surface of the back panel.

In another embodiment, the fastener comprises a hook-and-loop fastener.

Another embodiment further comprises a loofah sheet affixed to the back panel.

In another embodiment, the loofah sheet comprises a plurality of raised sections.

In another embodiment, the plurality of raised sections comprises twelve sections.

In another embodiment, each suction cup comprises an activation lever.

In another embodiment, the plurality of legs comprises four legs.

In another embodiment, the back panel is comprised of plastic.

Another embodiment provides a method of making a loofa holder, comprising: forming a back panel; affixing a wall fastening mechanism to a first side of the back panel; and affixing a loofa sheet fastening mechanism to a second side of the back panel.

In another embodiment, forming a back panel comprises using an injection molding process.

In another embodiment, forming a back panel further comprises forming a plurality of legs disposed on the first side of the back panel, and wherein affixing a wall fastening mechanism to the first side of the back panel comprises affixing a suction cup to each leg of the plurality of legs.

In another embodiment, affixing a loofa sheet fastening mechanism to a second side of the back panel comprises affixing a hook-and-loop fastener material to the second side of the back panel.

Another embodiment provides a method of using a loofah holder, comprising: applying a back panel to a shower wall; applying a loofah sheet to the back panel; contacting a back of a user to the back panel; and moving the back of the user relative to the back panel, thereby washing the back of the user.

In another embodiment, applying the back panel to the shower wall comprises: contacting the back panel to a shower wall; and activating a plurality of suction cups that are affixed to the back panel.

Another embodiment includes applying water to the loofah sheet.

Another embodiment includes applying liquid soap to the loofah sheet.

In another embodiment, applying liquid soap comprises using a spray bottle.

### BRIEF DESCRIPTION OF THE DRAWINGS

FIG. 1 is an upper perspective view of a loofah holder in accordance with embodiments of the present invention.

FIG. 2 is a lower perspective view of the loofah holder as shown in FIG. 1.

FIG. 3 is a front view of the loofah holder as shown in FIG. 1.

FIG. 4 is a back view of the loofah holder as shown in FIG. 1.

FIG. 5 is a side view of the loofah holder as shown in FIG. 1.

FIG. 6 is a top view of the loofah holder as shown in FIG. 1.

FIG. 7A is a top view of the loofah holder illustrating loofah sheet fasteners.

FIG. 7B is a top view of an alternative embodiment of the loofah holder illustrating loofah sheet fasteners.

FIG. 8 is a bottom view of the loofah holder as shown in FIG. 1.

FIG. 9 shows an exemplary installation of an embodiment of the present invention.

FIG. 10 shows a loofah sheet for use with embodiments of the present invention.

FIG. 11 shows an exemplary preparation for an embodiment of the present invention.

FIG. 12 shows an exemplary usage of an embodiment of the present invention.

The structure, operation, and advantages of disclosed embodiments will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity.

### DETAILED DESCRIPTION

Disclosed embodiments provide systems and methods for self-cleaning of a user's back. In embodiments, a back panel is affixed to a shower wall via one or more suction cups. The back panel includes a fastening mechanism that allows fastening of a loofah sheet to the back panel. The back panel is in a form with a concavity that contours to a human back. Water and/or liquid soap may be applied to the loofah sheet. The user can then walk backwards in the shower as to contact his/her back to the loofah sheet that is affixed to the back panel, and move his/her back relative to the back panel, thereby washing the back of the user. Thus, disclosed embodiments allow a user to effectively clean his/her own back, thereby improving skin health in heretofore hard-to-reach areas.

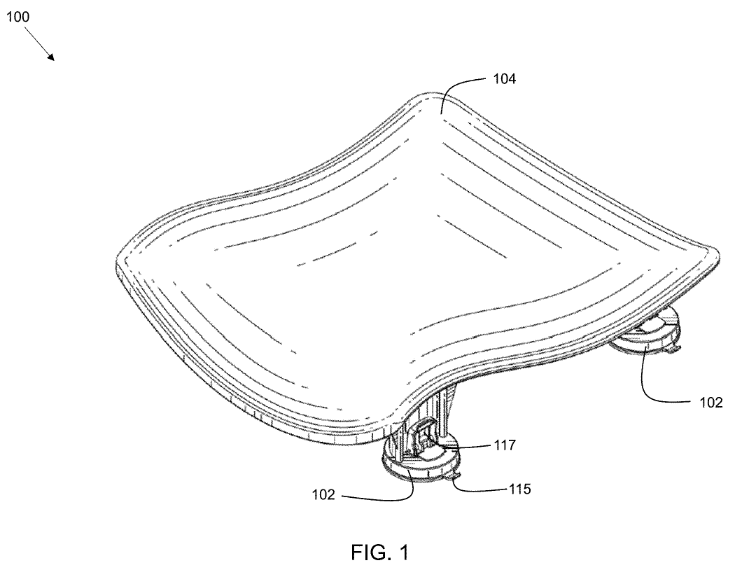

FIG. 1 is an upper perspective view of a loofah holder 100 in accordance with embodiments of the present invention. The loofah holder 100 includes a back panel 104, and a plurality of suction cups, indicated as 102. In embodiments, each suction cup 102 may include a lever 117, which can be used to activate the suction cup. As shown in FIG. 1, lever 117 is in the deactivated (up) position. To use disclosed embodiments, the loofah holder 100 is pressed against a shower wall while the lever 117 of each suction cup is in the deactivated position. This causes the suction cups to affix the loofah holder 100 to a shower wall. Then, each lever 117 is moved to an activated (down) position to more firmly secure the loofah holder to the shower wall before use by increasing the vacuum created by each suction cup. In embodiments, the lever is coupled to a diaphragm to increase the volume within the suction cup area to further enhance the suction. When the user is finished using the loofah holder 100, and wishes to remove it from the shower wall, the levers 117 can be returned to the deactivated position. The user may then pull tab 115 to break the seal of each suction cup, enabling an easy removal of the loofah holder 100 when no longer in use.

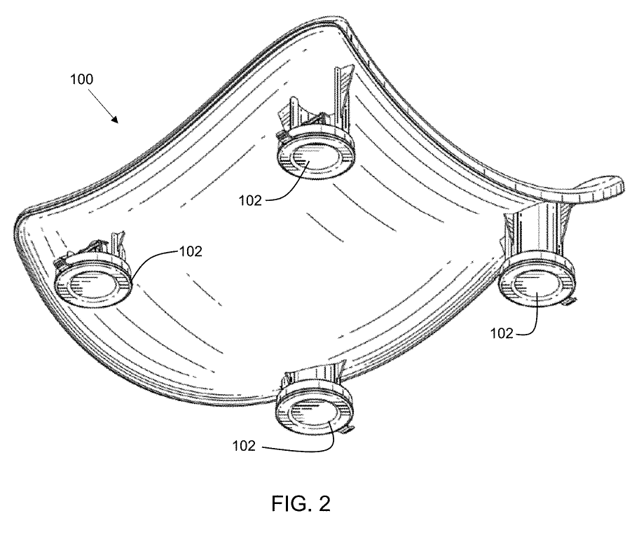

FIG. 2 is a lower perspective view of the loofah holder 100 as shown in FIG. 1. In this view, it can be seen that there are four suction cups 102 in this embodiment. Other embodiments may have more or fewer suction cups.

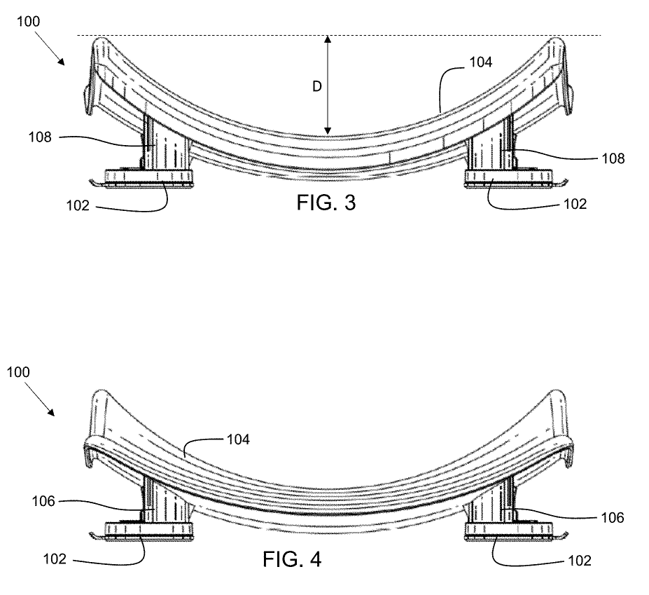

FIG. 3 is a front view of the loofah holder 100 as shown in FIG. 1. As can be seen in this view, a plurality of legs 108 extend from the back panel 104. A suction cup 102 is disposed on a distal end of each leg 108. As can be seen in FIG. 3, the back panel 104 has a concave shape to conform to the back of a user. Thus, in embodiments, the back panel comprises a concave cross section. The back panel 104 has a maximum concavity defined by the distance D from the highest point of the upper surface of the back panel 104 at the edges to the lowest point of the upper surface of the back panel 104 at the midpoint. In embodiments, the maximum concavity, as defined by distance D, ranges from 12 centimeters to 22 centimeters.

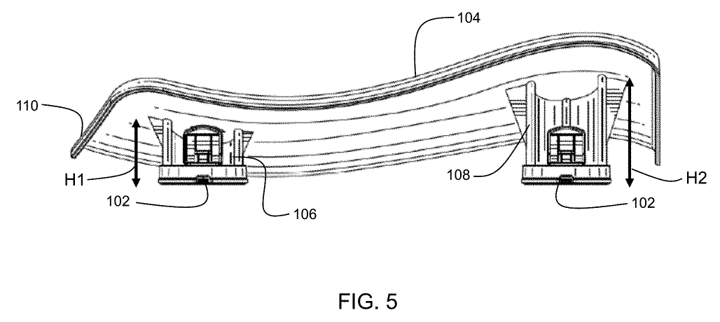

FIG. 4 is a back view of the loofah holder 100 as shown in FIG. 1. As can be seen in this view, a plurality of legs 106 extend from the back panel 104. A suction cup 102 is disposed on a distal end of each leg 106. In embodiments, the legs 106 of FIG. 4 and the legs 108 of FIG. 3 may be similar. In some embodiments, the legs 106 and the legs 108 may have different heights.

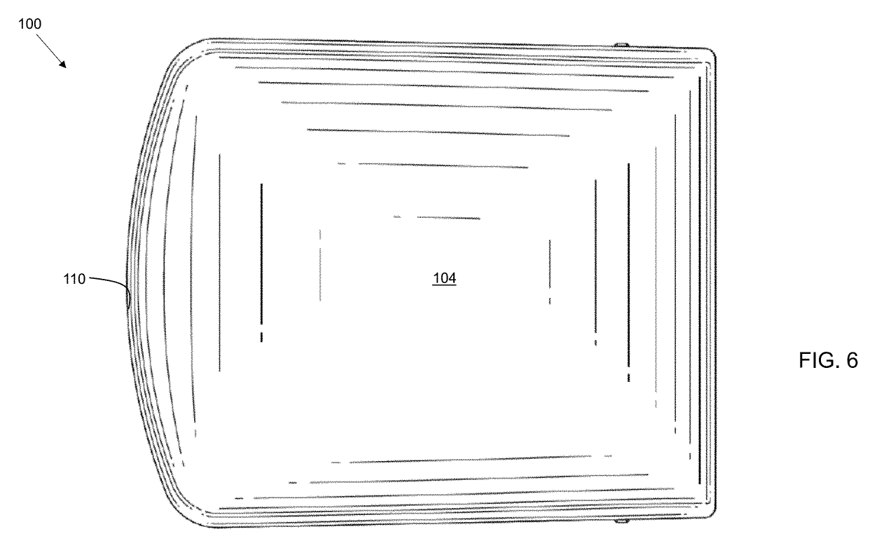

FIG. 5 is a side view of the loofah holder 100 as shown in FIG. 1. As can be seen in this view, legs 106 have a height H1, and legs 108 have a height H2, where H2 is greater than H1. In embodiments, H1 may range from 2 centimeters to 4 centimeters, and H2 may range from 5 centimeters to 6 centimeters. In embodiments, the plurality of legs comprises four legs.

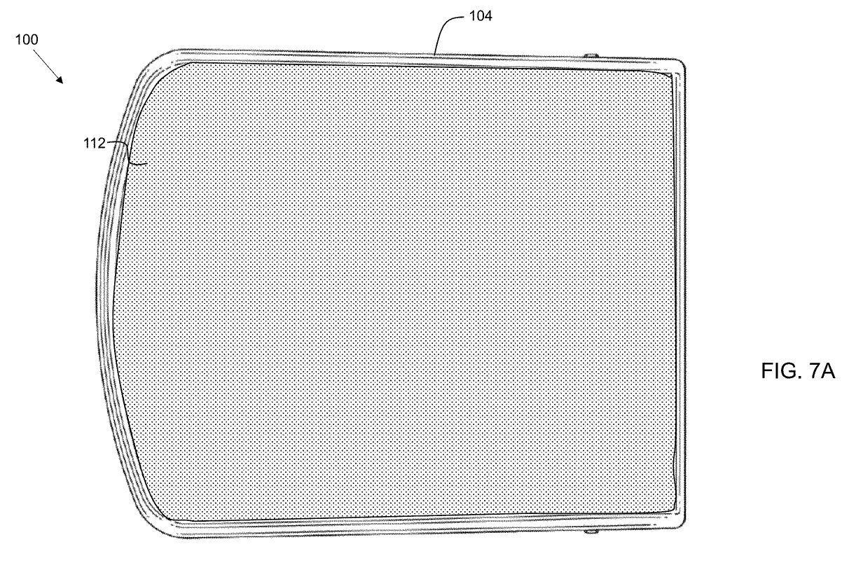

FIG. 6 is a top view of the loofah holder 100 as shown in FIG. 1. In embodiments, the back panel 104 may be comprised of plastic. In embodiments, the back panel 104 may be fabricated by injection molding, or other suitable technique. In some embodiments, the back panel and legs may be formed as an integral piece. In some embodiments, the back panel may be comprised of fiberglass, wood, stainless steel, or other suitable material.

In embodiments, the loofah holder 100 may be fabricated by forming a back panel; affixing a wall fastening mechanism (e.g. suction cups) to a first side of the back panel; and affixing a loofa sheet fastening mechanism (e.g. hook-and-loop fasteners) to a second side of the back panel. In some embodiments, forming a back panel further comprises forming a plurality of legs disposed on the first side of the back panel, and wherein affixing a wall fastening mechanism to the first side of the back panel comprises affixing a suction cup to each leg of the plurality of legs. In some embodiments, affixing a loofa sheet fastening mechanism to a second side of the back panel comprises affixing a hook-and-loop fastener material to the second side of the back panel.

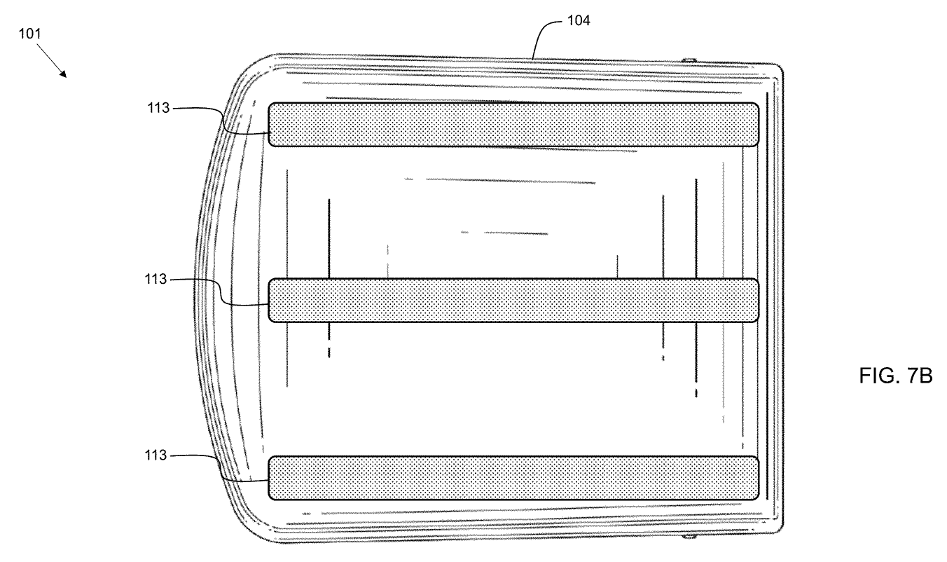

FIG. 7A is a top view of the loofah holder 100 illustrating loofah sheet fasteners. As shown in FIG. 7A, a hook-and-loop fastener 112 such as Velcro™ is affixed to a top surface of the back panel 104. This allows convenient attaching and removing of a loofah sheet.

FIG. 7B is a top view of a loofah holder 101 in accordance with an alternative embodiment of the present invention. As shown in FIG. 7B, multiple strips 113 of a hook-and-loop fastener such as Velcro™ are affixed to a top surface of the back panel 104. This allows convenient attaching and removing of a loofah sheet, while using less fastener material than the embodiment of FIG. 7A.

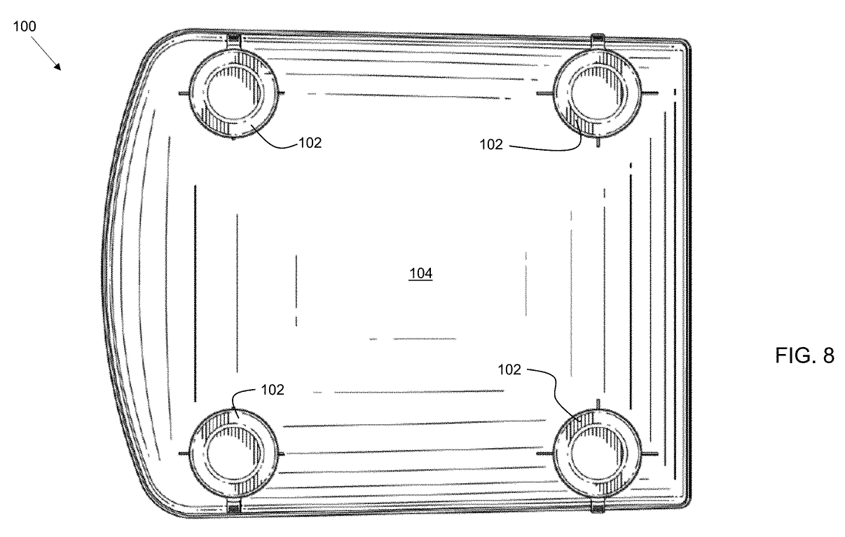

FIG. 8 is a bottom view of the loofah holder 100 as shown in FIG. 1. In this view, it can be seen that there are four suction cups 102 for this embodiment. The suction cups serve to affix the loofah holder 100 to a shower wall.

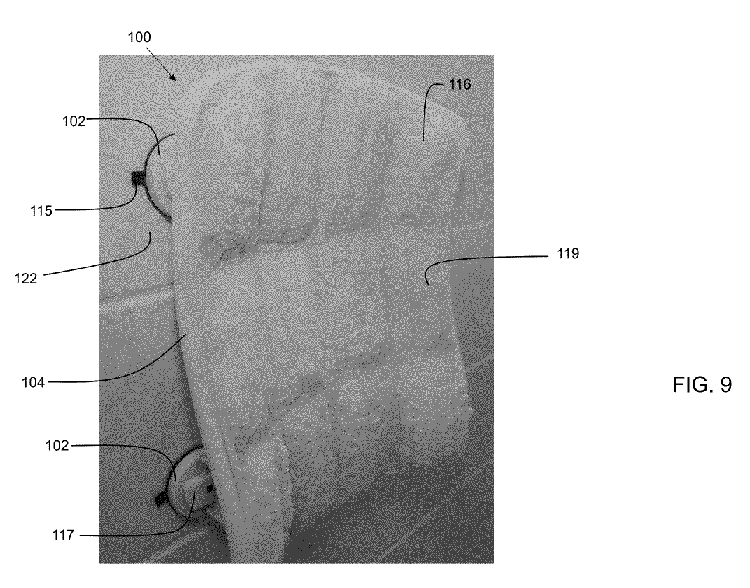

FIG. 9 shows an exemplary installation of an embodiment of the present invention. Loofah holder 100 is affixed to a shower wall 122 via suction cups 102. In embodiments, each suction cup includes an activation lever 117, shown in the activated (down) position in FIG. 9. A loofah sheet 116 is affixed to the back panel 104 via the hook-and-loop fastener. In alternative embodiments, another fastening mechanism may be used, such as snaps, elastic bands, zippers, and/or other suitable mechanisms. In embodiments, the loofah sheet 116 may include a plurality of raised sections 119. In embodiments, there are twelve such sections in the loofah sheet, arranged as three rows of four sections each. Other embodiments may have more or fewer sections. In some embodiments, the loofah sheet 116 may be comprised of twelve individual loofah pads that are stitched together using a very tight stitch to ensure that the loofah sheet 116 remains intact during use.

In some embodiments, the loofah sheet may be comprised of natural material such as dried-out tropical or subtropical gourd belonging to genus Luffa (such as species L. aegyptiaca or L. acutangula). In other embodiments, the loofah sheet may be comprised of a synthetic material such as nylon. A main purpose of the loofah sheet is to provide an exfoliation effect for the skin. Yet another use for the loofah sheet is to ensure a complete back wash, as opposed to only cleaning a limited area of the back due to not being able to reach over shoulders. Disclosed embodiments provide improved back washing for the elderly, disabled, and those with shoulder pain. Thus, a wide variety of exfoliant materials may be utilized for the loofah sheet in embodiments of the present invention.

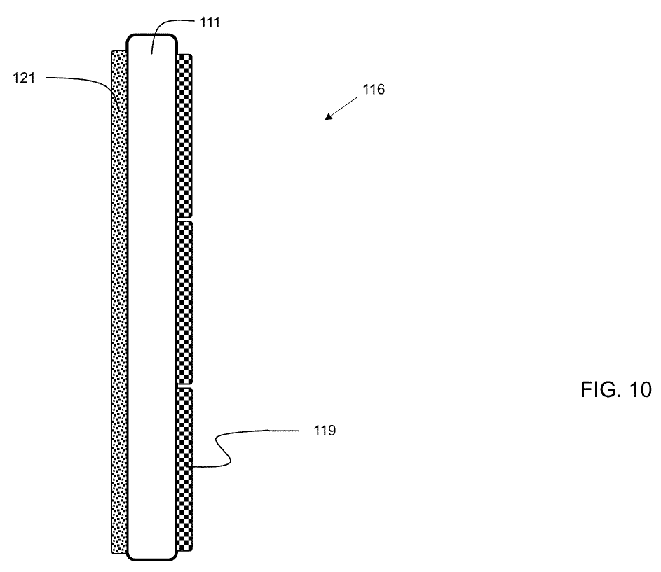

FIG. 10 shows a side view of a loofah sheet 116 for use with embodiments of the present invention. Loofah sheet 116 may include a textile portion 111. The textile portion can include, but is not limited to, cotton, nylon, and/or polyester. A loofah material, which may comprise one or more raised sections 119 is affixed to a first side of the textile portion 111. A hook-and-loop fastener 121 is affixed to a second side of the textile portion 111. The hook-and-loop fastener 121 is configured and disposed to engage with hook-and-loop fastener 112 of FIG. 7 during use. The loofah sheet 116 can be easily removed from the loofah holder for replacing and/or cleaning. Additionally, multiple users can use embodiments of the present invention, where each user may have his/her own loofah sheet. Each user attaches his/her loofah sheet to the loofah holder for use. In this way, sanitary conditions are preserved amongst multiple users.

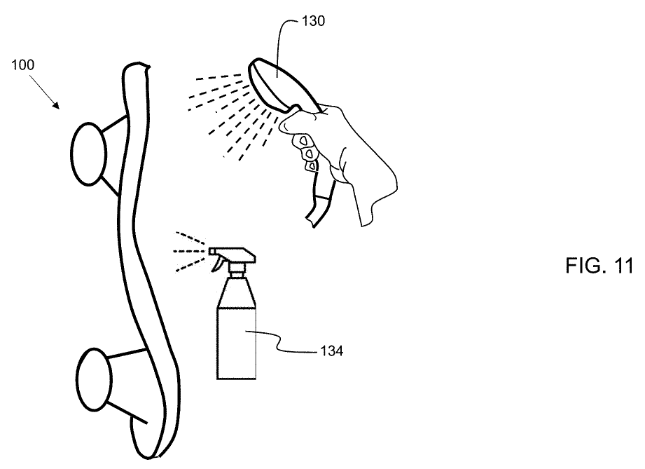

FIG. 11 shows an exemplary preparation for an embodiment of the present invention. Prior to using the loofah holder 100, it may be treated with water from a shower head 130 to moisten the loofah sheet attached to the loofah holder 100. Additionally, liquid soap may be applied to the loofah sheet from a spray bottle 134. Once treated, the system is now ready to be used by a user to enable self-cleaning of his/her own back.

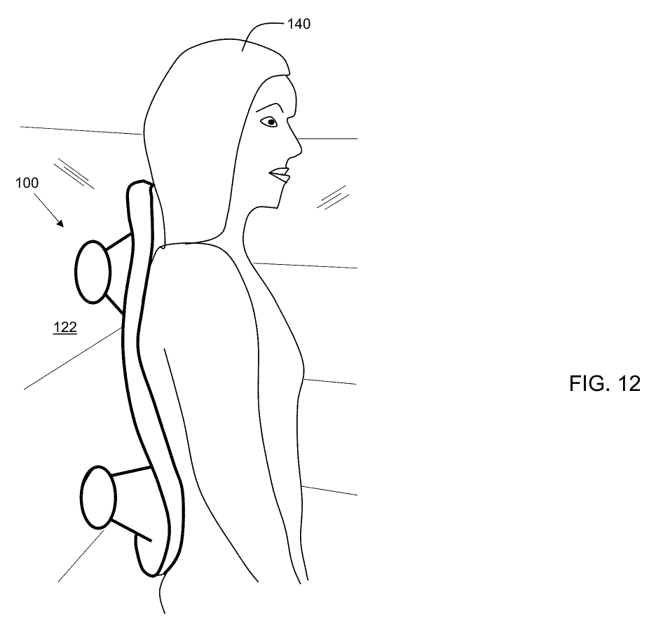

FIG. 12 shows an exemplary usage of an embodiment of the present invention. A user 140 is shown with her back against the loofah holder 100, which is affixed to the wall 122 of a shower stall. To install the loofah holder 100, the user may position the loofah holder against her back and lean back against wall 122. This causes the loofah holder 100 to stay in place against the wall at an appropriate height for that user. The user can then activate the suction cups via the corresponding levers (e.g. 117 of FIG. 9). The user then treats the attached loofah sheet with water and/or soap as shown in FIG. 11. The user can then move her back side-to-side and/or up and down against the loofah holder to thoroughly and efficiently exfoliate her back. This can serve to improve skin conditions such as acne, as well as provide a clean feeling to the back.

Embodiments therefore provide a method of using a loofah holder, comprising: applying a back panel to a shower wall; applying a loofah sheet to the back panel; contacting the back of a user to the back panel; and moving the back of the user relative to the back panel, thereby washing the back of the user. Embodiments can further include contacting the back panel to a shower wall; and activating a plurality of suction cups that are affixed to the back panel. Embodiments can further include applying water to the loofah sheet. Embodiments can further include applying liquid soap to the loofah sheet. In some embodiments, applying liquid soap comprises using a spray bottle to apply the soap to the loofah sheet.

As can now be appreciated, disclosed embodiments provide systems and methods for self-cleaning of a user's back. Embodiments may include a variety of sizes to accommodate small and large body sizes. Embodiments may be fabricated from a variety of materials, and a variety of fabrication techniques may be used.

Embodiments thus provide a simple, yet effective solution that changes the way people wash their backs. Simply stated, many people do not completely wash their backs because they cannot reach the entire back area. With disclosed embodiments, washing one's back is now simple and effortless. This allows the user to feel clean and refreshed while washing the oily pores and exfoliating the dead skin that has built up over years. Additionally, for people with shoulder pain, who may have trouble reaching their backs, disclosed embodiments provide a solution that requires little shoulder movement to enable effective cleaning of the back.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A loofah holder comprising:
a back panel;
a plurality of legs extending from the back panel; and
a suction cup disposed on each leg of the plurality of legs.

2. The loofah holder of claim 1, wherein the back panel comprises a concave cross section.

3. The loofah holder of claim 2, wherein the back panel comprises a maximum concavity ranging from 12 centimeters to 22 centimeters.

4. The loofah holder of claim 1, further comprising a fastener disposed on a top surface of the back panel.

5. The loofah holder of claim 4, wherein the fastener comprises a hook-and-loop fastener.

6. The loofah holder of claim 4, further comprising a loofah sheet affixed to the back panel.

7. The loofah holder of claim 6, wherein the loofah sheet comprises a plurality of raised sections.

8. The loofah holder of claim 7, wherein the plurality of raised sections comprises twelve sections.

9. The loofah holder of claim 1, wherein each suction cup comprises an activation lever.

10. The loofah holder of claim 1, wherein the plurality of legs comprises four legs.

11. The loofah holder of claim 1, wherein the back panel is comprised of plastic.

12. A method of making a loofa holder, comprising:
forming a back panel;
affixing a wall fastening mechanism to a first side of the back panel; and
affixing a loofa sheet fastening mechanism to a second side of the back panel.

13. The method of claim 12, wherein forming a back panel comprises using an injection molding process.

14. The method of claim 12, wherein forming a back panel further comprises forming a plurality of legs disposed on the first side of the back panel, and wherein affixing a wall fastening mechanism to the first side of the back panel comprises affixing a suction cup to each leg of the plurality of legs.

15. The method of claim 12, wherein affixing a loofa sheet fastening mechanism to a second side of the back panel comprises affixing a hook-and-loop fastener material to the second side of the back panel.

16. A method of using a loofah holder, comprising:
applying a back panel to a shower wall;
applying a loofah sheet to the back panel;
contacting a back of a user to the back panel; and
moving the back of the user relative to the back panel, thereby washing the back of the user.

17. The method of claim 16, wherein applying the back panel to the shower wall comprises:
contacting the back panel to a shower wall; and
activating a plurality of suction cups that are affixed to the back panel.

18. The method of claim 17, further comprising, applying water to the loofah sheet.

19. The method of claim 18, further comprising, applying liquid soap to the loofah sheet.

20. The method of claim 19, wherein applying liquid soap comprises using a spray bottle.
